(19) United States
(12) Patent Application Publication
(10) Pub. No.: US 2017/0002198 A1
(43) Pub. Date: Jan. 5, 2017

(54) Thermoplastic Resin Composition and Article Comprising the Same

(71) Applicant: Samsung SDI Co., Ltd., Yongin-si (KR)

(72) Inventors: Hee Yun JEONG, Uiwang-si (KR); Kee Hae KWON, Uiwang-si (KR); Chang Min HONG, Uiwang-si (KR)

(21) Appl. No.: 15/195,178

(22) Filed: Jun. 28, 2016

(30) Foreign Application Priority Data
Jun. 30, 2015 (KR) 10-2015-0093810

(51) Int. Cl. C08L 69/00

(52) U.S. Cl. CPC C08L 69/00; C08L 2207/04; C08L 2201/08; C08L 2203/20; C08L 2203/30; C08L 2205/025; C08L 2205/035; C08L 2205/06

(57) ABSTRACT

A thermoplastic resin composition and a molded article including the same. The thermoplastic resin composition includes: about 100 parts by weight of a base resin including (A) about 70 percent by weight (wt %) to about 95 wt % of a polycarbonate resin and (B) about 5 wt % to about 30 wt % of a polyester resin; and (C) about 0.5 parts by weight to about 6 parts by weight of a linear (meth)acrylic resin.

### CROSS-REFERENCE TO RELATED APPLICATION

This application claims priority under 35 USC Section 119 to and the benefit of Korean Patent Application No. 10-2015-0093810, filed on Jun. 30, 2015, in the Korean Intellectual Property Office, the entire disclosure of which is incorporated herein by reference.

### FIELD OF THE INVENTION

The present invention relates to a thermoplastic resin composition and a molded article including the same.

### BACKGROUND

Thermoplastic resins exhibit excellent properties, such as low specific gravity, good moldability, and good impact resistance, as compared with glass or metal, and are useful for housings of electrical/electronic products, automotive interior/exterior materials, and exterior materials for buildings. Particularly, with the trend toward larger and lighter electrical/electronic products, plastic products produced from thermoplastic resins are quickly replacing existing glass and metal-based products.

Particularly, it is known in the art that a blend of a polyester resin and a polycarbonate resin exhibits both properties of the polyester resin such as high mechanical strength and good moldability and properties of the polycarbonate resin such as good thermal resistance, impact stability and dimensional stability.

Recently, there is increasing demand for thermoplastic resin compositions having high fatigue resistance in order to increase lifespan and reliability of a molded article. However, when the amount of the polyester resin is increased in order to improve fatigue resistance of the thermoplastic resin composition, there is a problem of significant deterioration in thermal resistance.

### SUMMARY OF THE INVENTION

Embodiments of the present invention provide a thermoplastic resin composition that can exhibit good fatigue resistance and thermal resistance, and a molded article including the same.

The thermoplastic resin composition includes: about 100 parts by weight of a base resin including (A) about 70 percent by weight (wt %) to about 95 wt % of a polycarbonate resin and (B) about 5 wt % to about 30 wt % of a polyester resin; and (C) about 0.5 parts by weight to about 6 parts by weight of a linear (meth)acrylic resin.

In some embodiments, the polyester resin (B) may include at least one kind of polymer including a repeat unit represented by Formula 1:

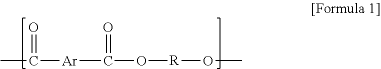

wherein Ar is a C₆ to C₁₈ arylene group and R is a C₁ to C₂₀ linear, branched or cyclic alkylene group.

In other embodiments, the polyester resin (B) may include about 60 percent by mole (mol %) to about 99 mol % of a repeat unit represented by Formula 1A and about 1 mol % to about 40 mol % of a repeat unit represented by Formula 1B:

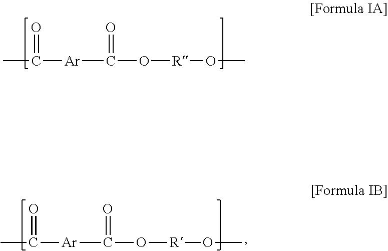

wherein each Ar is independently a C₆ to C₁₈ arylene group, R″ is a C₁ to C₂₀ linear or branched alkylene group, and R′ is a C₃ to C₂₀ cyclic alkylene group.

The polyester resin (B) may include at least one of polybutylene terephthalate (PBT) and polyethylene terephthalate (PET).

The linear (meth)acrylic resin (C) may be prepared by copolymerization of two kinds of C₁ to C₂₀ alkyl (meth)acrylates.

The linear (meth)acrylic resin (C) may be a copolymer of methyl methacrylate (MMA) and butyl acrylate (BA).

The linear (meth)acrylic resin (C) may have a glass transition temperature (Tg) of about 100° C. to about 150° C.

The copolymer of methyl methacrylate (MMA) and butyl acrylate (BA) may include methyl methacrylate (MMA) and butyl acrylate (BA) in a mole ratio of about 1:9 to about 9:1.

The thermoplastic resin composition may further include at least one additive of antimicrobial agents, heat stabilizers, release agents, photostabilizers, dyes, inorganic additives, surfactants, coupling agents, plasticizers, admixtures, lubricants, antistatic agents, pigments, toners, flame retardants, colorants, UV absorbers, UV blocking agents, fillers, nucleating agents, adhesive aids, and/or adhesives.

Other embodiments of the present invention relate to a molded article including the thermoplastic resin composition as set forth above.

The molded article may have a heat deflection temperature (HDT) of about 105° C. or higher, as measured under a load of 18.56 kgf/cm² in accordance with ASTM D648.

The molded article may have a fatigue resistance of about 40,000 cycles or more, as measured on a 3.2 mm thick specimen for measurement of tensile strength having a weld line at a center thereof at a frequency of 10 Hz under a load of 0.8 kN in accordance with ASTM D7791.

The present invention provides a thermoplastic resin composition that can exhibit good fatigue resistance and thermal resistance, and a molded article including the same.

### DETAILED DESCRIPTION

The above and other aspects, features, and advantages of the present invention will become apparent from the detailed description of the following embodiments. It should be understood that the present invention is not limited to the following embodiments and may be embodied in different ways, and that the embodiments are provided for complete disclosure and thorough understanding of the present invention by those skilled in the art. The scope of the present invention should be defined only by the appended claims.

As used herein, the term “(meth)acrylate” may include an acrylate and/or a methacrylate.

As used herein, the term “copolymer” may include an oligomer, a polymer and/or a resin.

As used herein, the term “linear (meth)acrylic resin” may refer to a (meth)acrylic alternating copolymer, a (meth)acrylic block copolymer, and/or a (meth)acrylic random copolymer, and may refer to a non-grafted or non-branched (meth)acrylic copolymer.

As used herein, the term “substituted polyester polymer” may refer to a polyester polymer, a diol component of which is partially substituted with another diol component.

As used herein, the term “fatigue resistance” means the number of cycles, which is measured on a 3.2 mm thick specimen for measurement of tensile strength having a weld line at the center thereof, at a frequency of 10 Hz under a load of 0.8 kN in accordance with ASTM D7791 until the specimen is fractured or cracks are generated in the specimen upon application of the load, in which 1 cycle refers to one period of applying a load of up to 0.8 kN to the specimen and releasing the load for 0.1 sec.

Hereinafter, a thermoplastic resin composition according to the present invention will be described in detail.

According to exemplary embodiments of the invention, a thermoplastic resin composition includes: about 100 parts by weight of a base resin including (A) about 70 wt % to about 95 wt % of a polycarbonate resin and (B) about 5 wt % to about 30 wt % of a polyester resin; and (C) about 0.5 parts by weight to about 6 parts by weight of a linear (meth)acrylic resin.

(A) Polycarbonate Resin

The polycarbonate resin (A) is a polycarbonate resin used in a typical thermoplastic resin composition. For example, the polycarbonate resin (A) may be an aromatic polycarbonate resin prepared by reacting one or more diphenols (for example, aromatic diol compounds) with a precursor, such as phosgene, halogen formate, and carbonic diester.

Examples of the diphenols may include without limitation 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-methyl-4-hydroxyphenyl)propane, 2,2-bis(3,5-dimethyl-4-hydroxyphenyl)propane, 2,2-bis(3-chloro-4-hydroxyphenyl)propane, 2,2-bis(3,5-dichloro-4-hydroxyphenyl)propane, and the like, and mixtures thereof. For example, the diphenols may include 2,2-bis(4-hydroxyphenyl)propane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, and/or 1,1-bis(4-hydroxyphenyl)cyclohexane, for example may include 2,2-bis(4-hydroxyphenyl)propane, which is also referred to as bisphenol A.

The polycarbonate resin (A) may include a branched polycarbonate resin. For example, the polycarbonate resin (A) may be a branched polycarbonate resin prepared by adding a tri- or higher polyfunctional compound, for example, a tri- or higher valent phenol group-containing compound, in an amount of about 0.05 mol % to about 2 mol % based on the total number of moles of the diphenols used in polymerization.

The polycarbonate resin (A) may include a homopolycarbonate resin, a copolycarbonate resin, or a blend thereof.

In addition, the polycarbonate resin (A) may be partly or completely replaced by an aromatic polyester-carbonate resin obtained through polymerization in the presence of an ester precursor, for example, a bifunctional carboxylic acid.

The polycarbonate resin (A) may have a weight average molecular weight (Mw) of about 10,000 g/mol to about 200,000 g/mol, for example about 15,000 g/mol to about 40,000 g/mol, for example, 20,000 g/mol, 28,000 g/mol, 30,000 g/mol, 32,000 g/mol, or 35,000 g/mol, as measured by gel permeation chromatography (GPC), without being limited thereto. Within this range of weight average molecular weights of the polycarbonate resin, a molded article formed of the thermoplastic resin composition can exhibit excellent properties in terms of flowability, thermal resistance, and/or rigidity.

The polycarbonate resin (A) may have a melt flow index (MI) of about 2 g/10 min to about 40 g/10 min, for example about 5 g/10 min to about 15 g/10 min, for example, 5 g/10 min, 6 g/10 min, 7 g/10 min, 8 g/10 min, 9 g/10 min, 10 g/10 min, 11 g/10 min, 12 g/10 min, 13 g/10 min, 14 g/10 min, or 15 g/10 min, as measured at about 250° C. under a load of about 10 kg in accordance with ISO 1133.

In exemplary embodiments, the polycarbonate resin (A) may be a blend of two kinds of polycarbonate resins having different melt flow indexes. For example, the polycarbonate resin (A) may be obtained by blending a first polycarbonate resin (a1) having a melt flow index of about 11 g/10 min to about 20 g/10 min and a second polycarbonate resin (a2) having a melt flow index of about 2 g/10 min to about 10 g/10 min, as measured at about 250° C. under a load of about 10 kg in accordance with ISO 1133. The first and second polycarbonate resins may be blended in a weight ratio of about 1:0.25 to about 1:8. Within this range, a molded article formed of the thermoplastic resin composition can exhibit excellent properties in terms of flowability, thermal resistance, and/or rigidity.

The base resin can include the polycarbonate resin (A) in an amount of about 70 wt % to about 95 wt %, for example about 75 wt % to about 95 wt %, and as another example about 80 wt % to about 95 wt %, based on the total weight (100 wt %) of the base resin. In some embodiments, the base resin can include the polycarbonate resin (A) in an amount of about 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments, the amount of the polycarbonate resin (A) can be in a range from about any of the foregoing amounts to about any other of the foregoing amounts.

Within this range, a molded article formed of the thermoplastic resin composition can exhibit further improved impact resistance and/or chemical resistance.

(B) Polyester Resin

In exemplary embodiments, the polyester resin (B) may include at least one kind of polymer including a repeat unit represented by Formula 1:

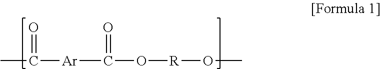

wherein Ar is a C₆ to C₁₈ arylene group and R is a C₁ to C₂₀ linear, branched or cyclic alkylene group.

For example, the polyester resin (B) may include a polymer of a dicarboxylic acid component including an aromatic dicarboxylic acid and a diol component including a C₁ to C₂₀ linear, branched or cyclic alkylene group.

The dicarboxylic acid component may include an aromatic dicarboxylic acid used in a typical polyester resin, for example, a C₈ to C₂₀ aromatic dicarboxylic acid. In addition, the dicarboxylic acid component may further include a linear and/or cyclic aliphatic dicarboxylic acid.

Examples of the aromatic dicarboxylic acid may include without limitation terephthalic acid (TPA), isophthalic acid (IPA), phthalic acid, 1,2-naphthalene dicarboxylic acid, 1,4-naphthalene dicarboxylic acid, 1,5-naphthalene dicarboxylic acid, 1,6-naphthalene dicarboxylic acid, 1,7-naphthalene dicarboxylic acid, 1,8-naphthalene dicarboxylic acid, 2,3-naphthalene dicarboxylic acid, 2,6-naphthalene dicarboxylic acid, and 2,7-naphthalene dicarboxylic acid; and aromatic dicarboxylates such as dimethyl terephthalate (DMT), dimethyl isophthalate, dimethyl-1,2-naphthalate, dimethyl-1,5-naphthalate, dimethyl-1,6-naphthalate, dimethyl-1,7-naphthalate, dimethyl-1,8-naphthalate, dimethyl-2,3-naphthalate, dimethyl-2,6-naphthalate, and dimethyl-2,7-naphthalate. These may be used alone or in combination thereof. In exemplary embodiments, terephthalic acid is used.

The diol component includes a diol including a C₁ to C₂₀ linear, branched or cyclic alkylene group and can provide good moldability and mechanical properties to a thermoplastic resin composition including the same.

Examples of the diol including a C₁ to C₂₀ linear, branched or cyclic alkylene group may include without limitation ethylene glycol, 1,3-propane-diol, 1,3-butanediol, 1,4-butanediol, 1,4-pentanediol, 1,5-pentanediol, 1,6-hexanediol, 3-methylpentane-2,4-diol, 2-methylpentane-1,4-diol, 2,2,4-trimethylpentane-1,3-diol, 2-ethylhexane-1,3-diol, 2,2-diethylpropane-1,3-diol, cyclohexanediol, cyclohexanedimethanol (CHDM), and the like, and mixtures thereof.

For example, the polyester resin (B) may include at least one of polybutylene terephthalate (PBT) and polyethylene terephthalate (PET).

In exemplary embodiments, the polyester resin (B) may include about 60 mol % to about 99 mol % of a repeat unit represented by Formula 1A and about 1 mol % to about 40 mol % of a repeat unit represented by Formula 1B, each based on the total mol % (100 mol %) of the polyester resin (B):

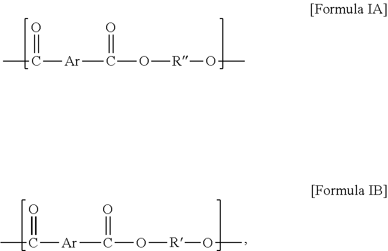

wherein each Ar is independently a C₆ to C₁₈ arylene group, R″ is a C₁ to C₂₀ linear or branched alkylene group, and R′ is a C₃ to C₂₀ cyclic alkylene group.

In some embodiments, the polyester resin (B) can include the repeat unit represented by Formula 1A in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 mol %. Further, according to some embodiments, the amount of the repeat unit represented by Formula 1A can be in a range from about any of the foregoing amounts to about any other of the foregoing amounts.

In some embodiments, the polyester resin (B) can include a repeat unit represented by Formula 1B in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mol %. Further, according to some embodiments, the amount of the repeat unit represented by Formula 1B can be in a range from about any of the foregoing amounts to about any other of the foregoing amounts.

For example, in Formula 1B, R′ may be a 1,4-cyclohexanedimethylene group, without being limited thereto. The 1,4-cyclohexanedimethylene group can improve miscibility between components of the resin composition, thereby minimizing post-deformation and post-shrinkage of a molded article formed of the resin composition.

In exemplary embodiments, the polyester resin (B) including about 60 mol % to about 99 mol % of the repeat unit represented by Formula 1A and about 1 mol % to about 40 mol % of the repeat unit represented by Formula 1B may be prepared through polycondensation of a dicarboxylic acid component including terephthalic acid; and a diol component including about 60 mol % to about 99 mol % of a C₂ to C₆ alkylene glycol and about 1 mol % to about 40 mol % of 1,4-cyclohexanedimethanol (CHDM). Within this range, the polyester resin (B) can improve miscibility between components of the thermoplastic resin composition while minimizing post-deformation and post-shrinkage of a molded article formed of the resin composition.

The diol component can include the C₂ to C₆ alkylene glycol in an amount of about 60 mol % to about 99 mol %, for example about 70 mol % to about 99 mol %, and as another example about 80 mol % to about 99 mol %, based on the total mol % (100 mol %) of the diol component used in polycondensation. In some embodiments, the diol component can include the C₂ to C₆ alkylene glycol in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 mol %. Further, according to some embodiments, the amount of the C₂ to C₆ alkylene glycol can be in a range from about any of the foregoing amounts to about any other of the foregoing amounts.

Within this range, the polyester resin (B) can improve miscibility between the components of the thermoplastic resin composition while minimizing post-deformation and post-shrinkage of a molded article formed of the resin composition.

The diol component can include 1,4-cyclohexanedimethanol (CHDM) in an amount of about 1 mol % to about 40 mol %, for example about 1 mol % to about 30 mol %, and as another example about 1 mol % to about 20 mol %, based on the total mol % (100 mol %) of the diol component used in polycondensation. In some embodiments, the diol component can include 1,4-cyclohexanedimethanol in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mol %. Further, according to some embodiments, the amount of 1,4-cyclohexanedimethanol can be in a range from about any of the foregoing amounts to about any other of the foregoing amounts.

Within this range, the polyester resin (B) can improve miscibility between the components of the thermoplastic resin composition while minimizing post-deformation and post-shrinkage of a molded article formed of the resin composition.

In exemplary embodiments, the polyester resin (B) may include a polymer including the repeat unit represented by Formula 1 and a polymer including about 60 mol % to about 99 mol % of the repeat unit represented by Formula 1A and about 1 mol % to about 40 mol % of the repeat unit represented by Formula 1B.

In these embodiments, the polyester resin (B) may include the polymer including about 60 mol % to about 99 mol % of the repeat unit represented by Formula 1A and about 1 mol % to about 40 mol % of the repeat unit represented by Formula 1B in an amount of about 0 wt % or more to about 20 wt % or less, for example about 0 wt % or more to about 15 wt % or less, and as another example about 0 wt % or more to about 10 wt % or less, based on the total weight (100 wt %) of the polyester resin (B). In some embodiments, the polyester resin (B) may include the polymer including about 60 mol % to about 99 mol % of the repeat unit represented by Formula 1A and about 1 mol % to about 40 mol % of the repeat unit represented by Formula 1B in an amount of about 0 (the polymer is present), 1, 2, 3, 4, 5, 6, 7, 8, 9, 10, 11, 12, 13, 14, 15, 16, 17, 18, 19, or 20 wt %. Further, according to some embodiments, the amount of the polymer including about 60 mol % to about 99 mol % of the repeat unit represented by Formula 1A and about 1 mol % to about 40 mol % of the repeat unit represented by Formula 1B can be in a range from about any of the foregoing amounts to about any other of the foregoing amounts.

Within this range, the polyester resin (B) can improve miscibility between the components of the thermoplastic resin composition and a molded article formed of the thermoplastic resin composition can exhibit excellent properties in terms of impact resistance, flowability, dimensional stability, external appearance, and the like.

In exemplary embodiments, the polyester resin (B) may have an inherent viscosity of about 0.4 dl/g to about 1.5 dl/g, for example about 0.5 dl/g to about 1.4 dl/g, for example, 0.5 dl/g, 0.6 dl/g, 0.7 dl/g, 0.77 dl/g, 0.8 dl/g, 0.9 dl/g, 1.0 dl/g, 1.1 dl/g, 1.2 dl/g, 1.3 dl/g, or 1.4 dl/g, as measured in an o-chloro phenol solution (concentration: 0.5 g/dl) at 35° C. Within this range of viscosity, the polyester resin (B) can improve miscibility between the components of the thermoplastic resin composition and a molded article formed of the thermoplastic resin composition can exhibit excellent properties in terms of impact resistance, flowability, dimensional stability, external appearance, and the like.

In exemplary embodiments, the polyester resin (B) including about 60 mol % to about 99 mol % of the repeat unit represented by Formula 1A and about 1 mol % to about 40 mol % of the repeat unit represented by Formula 1B may have an inherent viscosity of about 0.5 dl/g to about 1.0 dl/g, for example about 0.6 dl/g to about 0.9 dl/g, for example, 0.6 dl/g, 0.7 dl/g, 0.8 dl/g, or 0.9 dl/g, as measured in an o-chloro phenol solution (concentration: 0.5 g/dl) at 35° C. Within this range of viscosity, the polyester resin (B) can improve miscibility between the components of the thermoplastic resin composition and a molded article formed of the thermoplastic resin composition can exhibit excellent properties in terms of impact resistance, flowability, dimensional stability, external appearance, and the like.

The base resin can include the polyester resin (B) in an amount of about 5 wt % to about 30 wt %, for example about 5 wt % to 25 wt %, and as another example about 5 wt % to about 20 wt %, based on the total weight (100 wt %) of the base resin. In some embodiments, the base resin can include the polyester resin (B) in an amount of about 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the polyester resin (B) can be present in an amount of from about any of the foregoing amounts to about any other of the foregoing amounts.

Within this range, a molded article formed of the thermoplastic resin composition has good balance between mechanical properties and flowability.

In exemplary embodiments, the polycarbonate resin (A) and the polyester resin (B) may be present in a weight ratio of about 90:10 to about 30:10, for example, 90:10, 85:15, 80:20 or 72:25, in the base resin. Within this range of viscosity, the thermoplastic resin composition can have improved miscibility between the components thereof and the molded article formed of the thermoplastic resin composition can exhibit excellent properties in terms of impact resistance, flowability, dimensional stability, external appearance, and the like.

(C) Linear (Meth)Acrylic Resin

The linear (meth)acrylic resin (C) can improve thermal resistance and fatigue resistance of the thermoplastic resin composition.

The linear (meth)acrylic resin (C) may refer to a (meth)acrylic alternating copolymer, a (meth)acrylic block copolymer, and/or a (meth)acrylic random copolymer, and may refer to a non-grafted or non-branched (meth)acrylic copolymer.

As the amount of the polyester resin in the thermoplastic resin composition increases, the thermoplastic resin composition can exhibit increase in fatigue resistance together with significant deterioration in properties such as thermal resistance. The linear (meth)acrylic resin (C) included in the thermoplastic resin composition can allow a molded article formed of the thermoplastic resin composition to exhibit both fatigue resistance and thermal resistance even with a small amount of the polyester resin in the thermoplastic resin composition.

The linear (meth)acrylic resin (C) may be a copolymer of at least two kinds (two or more different ones) of C₁ to C₂₀ alkyl (meth)acrylates. Examples of the alkyl (meth)acrylates may include without limitation methyl (meth)acrylate, ethyl (meth)acrylate, propyl (meth)acrylate, n-butyl (meth)acrylate, t-butyl (meth)acrylate, iso-butyl (meth)acrylate, pentyl (meth)acrylate, hexyl (meth)acrylate, heptyl (meth)acrylate, ethylhexyl (meth)acrylate, octyl (meth)acrylate, isooctyl (meth)acrylate, nonyl (meth)acrylate, decyl (meth)acrylate, lauryl (meth)acrylate, and the like, and mixtures thereof.

For example, the linear (meth)acrylic resin (C) may be a copolymer of methyl methacrylate (MMA) and butyl acrylate (BA).

In exemplary embodiments, the copolymer of methyl methacrylate (MMA) and the butyl acrylate (BA) may include methyl methacrylate (MMA) and butyl acrylate (BA) in a mole ratio of about 1:9 to about 9:1, for example about 2:8 to about 8:2, and as another example about 3:7 to about 7:3, for example, 3:7 to 7:3, 4:6 to 6:4, or 5:5. Within this range, a molded article formed of the thermoplastic resin composition can have good properties in terms of both fatigue resistance and thermal resistance.

The linear (meth)acrylic resin (C) may be prepared by typical radical polymerization. For example, the linear (meth)acrylic resin (C) may be prepared by mixing two or more C₁ to C₂₀ alkyl (meth)acrylates, a radical polymerization initiator, and the like. Examples of the radical polymerization initiator may include peroxide, persulfate, azo cyanide compound, and/or redox-based initiators, without being limited thereto.

The linear (meth)acrylic resin (C) may have a glass transition temperature (Tg) of about 100° C. to about 150° C., for example about 110° C. to about 140° C., and as another example about 120° C. to about 130° C., for example, 120° C., 121° C., 122° C., 123° C., 124° C., 125° C., 125.5° C., 126° C., 127° C., 128° C., 129° C., or 130° C. Within this range, the linear (meth)acrylic resin (C) can improve moldability of the thermoplastic resin composition.

The thermoplastic resin composition can include the linear (meth)acrylic resin (C) in an amount of about 0.5 parts by weight to about 6 parts by weight, for example about 0.5 parts by weight to about 5 parts by weight, and as another example about 1 parts by weight to about 5 parts by weight, based on about 100 parts by weight of the base resin.

In some embodiments, the thermoplastic resin composition can include the linear (meth)acrylic resin (C) in an amount of about 0.5, 0.6, 0.7, 0.8, 0.9, 1, 2, 3, 4, 5, or 6 parts by weight. Further, according to some embodiments of the present invention, the linear (meth)acrylic resin (C) can be present in an amount of from about any of the foregoing amounts to about any other of the foregoing amounts.

Within this range, a molded article formed of the thermoplastic resin composition can exhibit excellent properties in terms of both fatigue resistance and thermal resistance.

Additive(s)

The thermoplastic resin composition according to the present invention may further include at least one or more additives, as needed. Examples of the additives can include without limitation antimicrobial agents, heat stabilizers, release agents, photostabilizers, dyes, inorganic additives, surfactants, coupling agents, plasticizers, admixtures, lubricants, antistatic agents, pigments, toners, flame retardants, colorants, UV absorbers, UV blocking agents, fillers, nucleating agents, adhesive aids, adhesives, and the like, and mixtures thereof.

The amount of the additive may be determined depending upon purposes of the thermoplastic resin composition without deteriorating the properties of the thermoplastic resin composition.

The thermoplastic resin composition according to the embodiments of the invention may be prepared by a typical method known in the art. For example, the above components and, optionally, one or more other additives can be mixed using a Henschel mixer, a V blender, a tumbler blender, or a ribbon blender, followed by melt extrusion at about 150° C. to about 350° C. in a single-screw extruder or a twin-screw extruder, thereby preparing a thermoplastic resin composition in pellet form. For example, the mixture of the components and the additive can be subjected to extrusion at about 250° C. to about 310° C. using a twin screw extruder (L/D=29, φ=36 mm), thereby preparing the thermoplastic resin composition in pellet form.

A molded article according to the present invention is formed of the thermoplastic resin composition. For example, the molded article may be produced using the thermoplastic resin composition by a method known in the art, for example, injection molding, blow molding, extrusion molding, casting molding, or the like. The molded article may have a heat deflection temperature (HDT) of about 105° C. or higher, for example about 105° C. to about 110° C., for example, 105° C., 105.5° C., 105.8° C., 106° C., 106.1° C., 107° C., 108° C., 109° C., or 110° C., as measured under a load of 18.56 kgf/cm² in accordance with ASTM D648.

The molded article may have a fatigue resistance of about 40,000 cycles or more, for example about 45,000 cycles or more, and as another example about 50,000 cycles or more, for example, about 50,000 cycles to about 70,000 cycles, as measured on a 3.2 mm thick specimen for measurement of tensile strength having a weld line at the center thereof at a frequency of 10 Hz under a load of 0.8 kN in accordance with ASTM D7791.

Next, the present invention will be described in more detail with reference to the following examples. It should be understood that these examples are provided for illustration only and are not to be construed in any way as limiting the present invention. Descriptions of details apparent to those skilled in the art will be omitted.

### EXAMPLES

Details of components used in Examples and Comparative Examples are as follows.

(A) Polycarbonate Resin

(a1) A product (available from Samsung SDI Chemicals) having a weight average molecular weight of 28,000 g/mol and a melt flow index MI of 12 g/10 min (as measured at 250° C. under a load of 10 kg in accordance with ISO 1133) is used.

(a2) A product (available from LG Chemicals) having a weight average molecular weight of 32,000 g/mol and a melt flow index MI of 5 g/10 min (as measured at 250° C. under a load of 10 kg in accordance with ISO 1133) is used.

(B) Polyester Resin

(b1) Shinite DHK011 (Shinkong Co., Ltd.) as polybutylene terephthalate having an intrinsic viscosity of 1.2±0.2 dl/g is used.

(b2) Shinite K006 (Shinkong Co., Ltd.) as polybutylene terephthalate having an intrinsic viscosity of 1.1±0.2 dl/g is used.

(b3) BL-8050 (SK Chemical Co., Ltd.) as polyethylene terephthalate having an intrinsic viscosity of 0.77±0.2 dl/g is used.

(C) Linear (Meth)Acrylic Resin

Plastistrength 552 (Arkema Co., Ltd.) as a linear copolymer (glass transition temperature (Tg): 125.5° C.)) of methyl methacrylate (MMA) and butyl acrylate (BA) is used.

(C′) Non-linear (meth)acrylic resin of core-shell structure: Kane Ace FM-40 (Kakeka Co., Ltd.) as a core-shell copolymer having a core composed of butyl acrylate (BA) and a shell composed of poly(methyl methacrylate) (PMMA) is used.

### Example 1

30 wt % of (a1) and 60 wt % of (a2) as polycarbonate resins, 10 wt % of (b1) as a polyester resin and 1.5 parts by weight of the (C) linear (meth)acrylic resin are mixed in amounts as listed in Table 1, followed by extrusion using a twin-screw extruder (L/D=29, φ=36 mm) at 260° C., thereby preparing a resin composition in pellet form using a pelletizer. The resin composition is dried in an oven at 120° C. for 4 hours and is injection-molded using an injection molding machine (Model No. DHC 120WD, Donshin Hydraulic Company) at a molding temperature of 270° C. and a mold temperature of 70° C. to produce a 3.2 mm thick specimen for measurement of tensile strength having a weld line at the center thereof and a specimen for measurement of heat deflection temperature.

### Examples 2 to 4 and Comparative Examples 1 to 5

Specimens are produced in the same manner as in Example 1 except for using the compositions as listed in Table 1.

TABLE 1

| | | | | | | Comparative | | | | |
|---|---|---|---|---|---|---|---|---|---|---|
| | | Example | | | | Example | | | | |
| | | 1 | 2 | 3 | 4 | 1 | 2 | 3 | 4 | 5 |
| (A) | (a1) | 30 | 10 | 50 | 65 | 30 | 30 | 50 | 30 | 65 |
| | (a2) | 60 | 80 | 25 | 20 | 60 | 35 | 25 | 40 | 20 |
| (B) | (b1) | 10 | — | 15 | 5 | 10 | 35 | 15 | 15 | 5 |
| | (b2) | — | 10 | — | — | — | — | — | — | — |
| | (b3) | — | — | 10 | 10 | — | — | 10 | 15 | 10 |

| | | | | | | | | | |
|---|---|---|---|---|---|---|---|---|---|
| (A) + (B) (wt %) | 100 | 100 | 100 | 100 | 100 | 100 | 100 | 100 | 100 |
| (C) (parts by | 5 | 5 | 1.5 | 3 | — | — | — | 7 | — |
| weight) | | | | | | | | | |
| (C′) (parts by | — | — | — | — | — | — | — | — | 3 |
| weight) | | | | | | | | | |

The specimens produced in the Examples and Comparative Examples are evaluated as to the following properties and evaluation results are shown in Table 2.

Evaluation of Properties

(1) Thermal resistance (heat deflection temperature, unit: ° C.): Heat deflection temperature (HDT) is measured under a load of 18.56 kgf/cm² in accordance with ASTM D648.

(2) Fatigue resistance (unit: cycle): The number of cycles is measured on a 3.2 mm thick specimen for measurement of tensile strength having a weld line at the center thereof under conditions of 10 Hz and 0.8 kN using a fatigue resistance tester (Model No. 8872, Instron Technology Inc.) in accordance with ASTM D7791 until the specimen is fractured or cracks are generated in the specimen upon application of the load thereto. Here, 1 cycle is defined as one period of applying a load of up to 0.8 kN to the specimen and releasing the load for 0.1 sec.

TABLE 2

| | Example | | | | Comparative Example | | | | |
|---|---|---|---|---|---|---|---|---|---|
| | 1 | 2 | 3 | 4 | 1 | 2 | 3 | 4 | 5 |
| Heat deflection | 105.5 | 105.8 | 105.5 | 106.1 | 104.8 | 96.5 | 102.1 | 102.6 | 103.0 |
| temperature | | | | | | | | | |
| (° C.) | | | | | | | | | |
| Fatigue resistance | 55,871 | 57,671 | 68,556 | 53,138 | 22,450 | 56,521 | 26,776 | 32,885 | 26,186 |
| (cycles) | | | | | | | | | |

As shown in Table 2, it can be seen that the thermoplastic resin compositions of the Examples satisfying the conditions of the present invention exhibit excellent properties in terms of both fatigue resistance and thermal resistance.

Although some embodiments have been described above, it should be understood that these embodiments are provided for illustration only and are not to be construed in any way as limiting the present invention, and that various modifications, changes, and alterations can be made by those skilled in the art without departing from the spirit and scope of the invention. Therefore, the scope of the present invention should be defined by the appended claims and equivalents thereof.

What is claimed is:

1. A thermoplastic resin composition comprising:
about 100 parts by weight of a base resin comprising (A) about 70 wt % to about 95 wt % of a polycarbonate resin and (B) about 5 wt % to about 30 wt % of a polyester resin; and
(C) about 0.5 parts by weight to about 6 parts by weight of a linear (meth)acrylic resin.

2. The thermoplastic resin composition according to claim 1, wherein the polyester resin (B) comprises at least one polymer comprising a repeat unit represented by Formula 1: 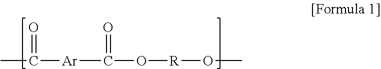
wherein Ar is a C₆ to C₁₈ arylene group and R is a C₁ to C₂₀ linear, branched or cyclic alkylene group.

3. The thermoplastic resin composition according to claim 1, wherein the polyester resin (B) comprises about 60 mol % to about 99 mol % of a repeat unit represented by Formula 1A and about 1 mol % to about 40 mol % of a repeat unit represented by Formula 1B: 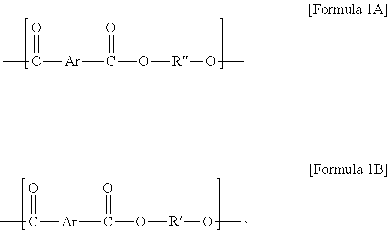
wherein each Ar is independently a C₆ to C₁₈ arylene group, R″ is a C₁ to C₂₀ linear or branched alkylene group, and R′ is a C₃ to C₂₀ cyclic alkylene group.

4. The thermoplastic resin composition according to claim 1, wherein the polyester resin (B) comprises at least one of polybutylene terephthalate (PBT) and polyethylene terephthalate (PET).

5. The thermoplastic resin composition according to claim 1, wherein the linear (meth)acrylic resin (C) is prepared by copolymerization of two or more C₁ to C₂₀ alkyl (meth)acrylates.

6. The thermoplastic resin composition according to claim 1, wherein the linear (meth)acrylic resin (C) is a copolymer of methyl methacrylate (MMA) and butyl acrylate (BA).

7. The thermoplastic resin composition according to claim 1, wherein the linear (meth)acrylic resin (C) has a glass transition temperature (Tg) of about 100° C. to about 150° C.

8. The thermoplastic resin composition according to claim 6, wherein the copolymer of methyl methacrylate (MMA) and butyl acrylate (BA) comprises methyl methacrylate (MMA) and butyl acrylate (BA) in a mole ratio of about 1:9 to about 9:1.

9. The thermoplastic resin composition according to claim 1, further comprising at least one additive selected from the group consisting of antimicrobial agents, heat stabilizers, releasing agents, photostabilizers, dyes, inorganic additives, surfactants, coupling agents, plasticizers, admixtures, lubricants, antistatic agents, pigments, toners, flame retardants, colorants, UV absorbers, UV blocking agents, fillers, nucleating agents, adhesive aids, adhesives, and mixtures thereof.

10. A molded article comprising the thermoplastic resin composition according to claim 1.

11. The molded article according to claim 10, wherein the molded article has a heat deflection temperature (HDT) of about 105° C. or higher, as measured under a load of 18.56 kgf/cm² in accordance with ASTM D648.

12. The molded article according to claim 10, wherein the molded article has a fatigue resistance of about 40,000 cycles or more, as measured on a 3.2 mm thick specimen for measurement of tensile strength having a weld line at a center thereof at a frequency of 10 Hz under a load of 0.8 kN in accordance with ASTM D7791.
